(19) United States
(12) Patent Application Publication
(10) Pub. No.: US 2003/0118172 A1
(43) Pub. Date: Jun. 26, 2003

(54) VDSL system

(76) Inventor: Minoru Dendou, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 10/113,278

(22) Filed: Apr. 1, 2002

(30) Foreign Application Priority Data
Dec. 26, 2001 (JP) 2001-393007

(51) Int. Cl. H04M 3/00; H04M 5/00

(52) U.S. Cl. 379/242; 379/325

(57) ABSTRACT

Telephone sets 2-1 to 2-n and computers 1-1 to 1-n are connected to a terminal board 6 via common home-side wires 9-1 to 9-n. This terminal board 6 has a structure in which telephone wires 14-1 to 14-n from a public telephone network 61 are connected thereto while the home-side wires 9-1 to 9-n branch off to a line concentration switch 7 therein and terminal-board-side splitters 13-1 to 13-n connected between the telephone wires 14-1 to 14-n and the home-side wires 9-1 to 9-n are disposed therein, so that the telephone sets 2-1 to 2-n can use a telephone service via the public telephone network 61 and the computers 1-1 to 1-n can perform high-speed data communication with the Internet 62 by a VDSL service using an optical fiber cable 10 via a router 8 connected to the line concentration switch 7.

### BACKGROUND OF THE INVENTION

1. Field of the Invention

The present invention relates to a VSDL system (Very High-Bit-Rate Digital Subscriber Line) and constituent elements thereof, and more particularly, to those realizing configuration simplification and so on.

2. Description of the Related Art

As is conventionally and generally known, VDSL is one form of a communication technology generally called xDSL, which has enabled high-speed data communication in which high-speed digital data is transmitted together with telephone signals using an existing subscriber telephone line.

Compared with ADSL (Asymmetric DSL), which is also one form of xDSL and in which data is transmitted in a frequency band of 1.1 MHz or lower, in this VDSL, a frequency band is expanded about ten times as that in ADSL to increase the maximum transmission speed to a great extent.

However, the increase in the maximum transmission speed has caused conspicuous attenuation of a line itself compared with ADSL so that a metallic cable such as ADSL can be put into practical use only in data transmission of a short distance of about one kilometer. Therefore, FTTH (Fiber To The Home) in which an optical cable is laid to each home and FTTB (Fiber To The Basement) in which an optical cable is laid to entrances of an apartment house and an office building are recommended as a signal transmission means of VDSL. However, since concrete activities for putting FTTH in practical use have just started and, in addition, it costs very high for a personal user, the form of using FTTB is in the mainstream under the present circumstances.

In the VDSL system using such FTTB, a form in which a plurality of users utilize a VDSL service in buildings such as an apartment house and an office building is a basic form. Therefore, in an apartment house and the like to which a VDSL service is provided, telephone wires corresponding to the number of users are generally laid and are usually connected to splitters or the like via a connecting part called a terminal board which is installed inside the building.

More specifically, for example, telephone wire connecting terminals 22a, 22b and home-side connecting terminals 23a, 23b are provided for one subscriber telephone line in a terminal board 21 as shown in FIG. 5, in which a part of the terminal board 21 is shown, and the telephone wire connecting terminals 22a, 22b and the home-side connecting terminals 23a, 23b are mutually connected in advance.

To the telephone wire connecting terminals 22a, 22b, telephone wires 24a, 24b are connected, while to the home-side connecting terminals 23a, 23b, home-side connecting wire 25a, 25b for connection to not-shown home-side equipments such as a splitter are connected.

However, the terminal board 21 as described above is conventionally disposed separately from a not-shown element called a splitter which is connected to the home-side connecting terminals 23a, 23b and which separates telephone signals from digital data and synthesizes them. Especially in the above-described VDSL system having many users, this not only causes the necessity of securing spaces for disposing the splitters as many as the number of users separately from the terminal board 21 but also causes the increase in the number of elements and equipments which need wiring work, and results in a problem of increase in system price and so on.

### SUMMARY OF THE INVENTION

The present invention is made in view of the above-described circumstances, and it is an object of the present invention to provide a VDSL system, a terminal board for a VDSL system, and a connecting terminal block for a VDSL system which can realize simplification of wiring work in system configuration.

It is another object of the present invention to provide a VDSL system, a terminal board for a VDSL system, and a connecting terminal block for a VDSL system which do not require a large space for part disposition to be secured.

According to a first aspect of the present invention,

provided is a VDSL system configured to enable connection of a telephone set to a public telephone network and connection of a computer to the Internet by a VDSL service via a common wire laid inside a building where the telephone set and the computer are installed, comprising:

a terminal board which is disposed between a telephone wire from the public telephone network and the common wire, to which the telephone wire and the common wire are connected, and which is integrally structured with a terminal-board-side splitter disposed between the telephone wire and the common wire.

In the configuration described above, the splitter connected to the telephone wire is structured integrally with a connecting terminal block via which connection among wiring is realized, so that, unlike in a conventional art, spaces for disposing the splitters separately need not be secured and a VDSL system can be configured with less wiring work compared with a conventional art.

According to a second aspect of the present invention,

provided is a terminal board for a VDSL system,

which is installed in a centralized protector room provided inside a collective building where a plurality of telephone sets and computers are provided and where the computers are enabled to execute high-speed data communication by a VDSL service, and the terminal board comprising:

terminal-board-side splitters which are disposed according to the number of the telephone sets and via which telephone wires from an external part laid according to the number of the plural telephone sets and a plurality of common wires are connected to each other, the plural telephone sets and computers being commonly connected to the common wires, and

in which branched wiring is made possible on a side of the terminal-side splitters to which the plural common wires are connected.

According to a third aspect of the present invention,

provided is a connecting terminal block for a VDSL system, comprising:

telephone wire connecting terminals to which telephone wires from a public telephone network are connected;

home-side connecting terminals to which common wires are connected; and

switch connecting terminals to which wires to a line concentration switch are connected, and

terminal-board-side splitters which are connected between the telephone wire connecting terminals and the home-side connecting terminals and which are disposed in the connecting terminal block,

wherein the switch connecting terminals and the home-side connecting terminals are in a state of being electrically connected to each other.

### BRIEF DESCRIPTION OF THE DRAWINGS

FIG. 1 is a block diagram showing a configuration example of a VDSL system in an embodiment of the present invention;

FIG. 2 is a perspective view showing a whole external appearance of a terminal board used in the VDSL system shown in FIG. 1;

FIG. 3 is a block diagram showing a configuration example of the terminal board used in the VDSL system shown in FIG. 1;

FIG. 4 is a perspective view specifically showing one example of a whole external appearance of a connecting terminal block; and

FIG. 5 is a schematic view schematically showing one example of a conventional terminal board.

### DETAILED DESCRIPTION OF THE PREFERRED EMBODIMENTS

The present invention will be hereinafter explained in detail with reference to the attached drawings.

Incidentally, it is to be understood that the present invention is not intended to be limited to members, dispositions, and so forth which will be described below, and various modifications and improvements may be made therein without departing from the spirit of the present invention.

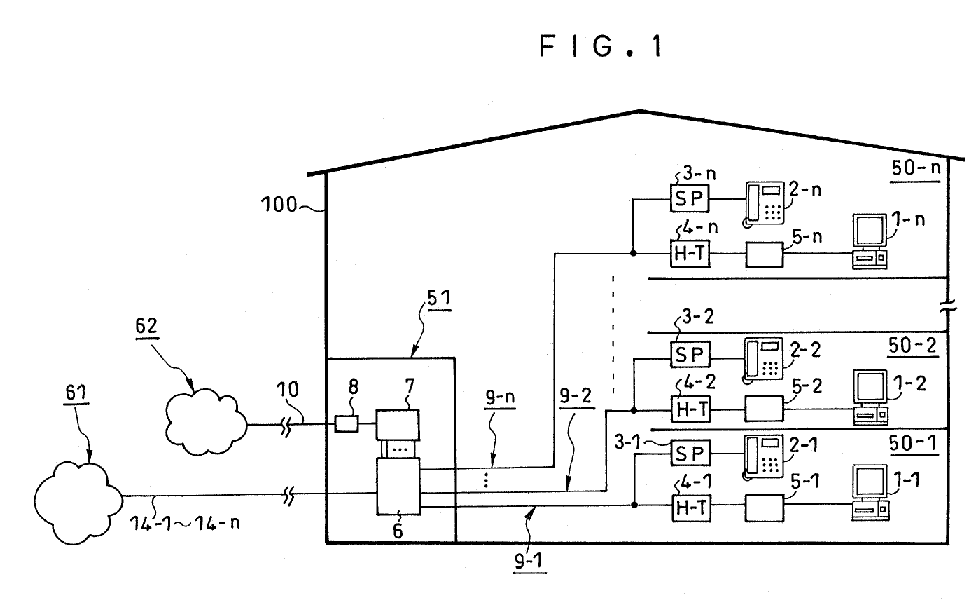

First, a configuration of a VDSL system in an embodiment of the present invention will be explained with reference to FIG. 1.

A VDSL system in the embodiment of the present invention is especially suitable when it is configured in a collective building 100 such as a condominium, an apartment house, an office building, and so on where a plurality of users exist.

Inside the collective building 100, a plurality of sections 50-1 to 50-n, each of which constitutes a minimum unit of living space or office space, are formed, and furthermore, a centralized protector room 51 in which a terminal board 6 and so on are installed as described later is formed.

First, in the sections 50-1 to 50-n, personal computers 1-1 to 1-n which are used for a VDSL service and the like by the respective users and the telephone sets 2-1 to 2-n are installed respectively. The telephone sets 2-1 to 2-n and the personal computers 1-1 to 1-n in all the sections 50-1 to 50-n are connected to the terminal board 6 installed in a centralized protector room 51 in the manner as described below.

Specifically, the telephone sets 2-1 to 2-n are connected to connecting parts of user-side splitters (denoted by ‘SP’ in FIG. 1) 3-1 to 3-n and are connected to a terminal board 6, which will be described later, via the user-side splitters 3-1 to 3-n by home-side wires 9-1 to 9-n, which also connects later-described hybrid transformers (denoted by ‘H-T’ in FIG. 1) 4-1 to 4-n to a terminal board 6.

Meanwhile, to the personal computers 1-1 to 1-n, VDSL modems 5-1 to 5-n are connected, and these VDSL modems 5-1 to 5-n are further connected to connecting parts of the hybrid transformers 4-1 to 4-n. The other connecting parts of the hybrid transformers 4-1 to 4-n are connected to the other connecting parts of the user-side splitters 3-1 to 3-n, and are also connected to a terminal board 6 by the home-side wires 9-1 to 9-n commonly used by the telephone sets 2-1 to 2-n, as described above.

The user-side splitters 3-1 to 3-n have a conventionally and generally known structure in which telephone signals and digital data signals are separated and synthesized.

The VDSL modems 5-1 to 5-n have a conventionally and generally known structure in which signals inputted from the personal computers 1-1 to 1-n are modulated and signals inputted to the personal computers 1-1 to 1-n are demodulated to enable communication through the personal computers 1-1 to 1-n, using the VDSL service.

The hybrid transformers 4-1 to 4-n prevent sneak path of telephone signals outputted from the telephone sets 2-1 to 2-n to the personal computers 1-1 to 1-n and prevent sneak path of digital signals outputted from the personal computers 1-1 to 1-n to the telephone sets 2-1 to 2-n, and have a conventionally and generally known structure.

Meanwhile, the centralized protector room 51 is a room where the terminal board 6, a line concentration switch 7, and a router 8 are installed together with devices and so on (not shown) for protecting electric facilities of the collective building 100.

To a terminal board 6, telephone wires 14-1 to 14-n connected to an external public telephone network 61 and the home-side wires 9-1 to 9-n from the telephone sets 2-1 to 2-n and the personal computers 1-1 to 1-n in the aforesaid respective sections 50-1 to 50-n are connected respectively while a terminal board 6 is also connected to the line concentration switch 7 (described in detail later).

The line concentration switch 7 has a conventionally and generally known structure in which it interconnects output signals from the personal computers 1-1 to 1-n in the respective sections 50-1 to 50-n to the router 8 while it outputs signals destined for the personal computers 1-1 to 1-n from an external part via the router 8, to the corresponding personal computers 1-1 to 1-n, and it is structured to be connected to the personal computers 1-1 to 1-n via a connecting terminal block 12 as described later.

The router 8 has a conventionally and generally known structure in which it fulfils an interconnecting function between the personal computers 1-1 to 1-n and the Internet 62 by the VDSL service, and in the embodiment of the present invention, when it is connected to a so-called provider (not shown) which provides a VDSL service through an optical fiber cable 10, it can be connected to the Internet 62. Therefore, a VDSL service is in a form of using FTTB in the embodiment of the present invention.

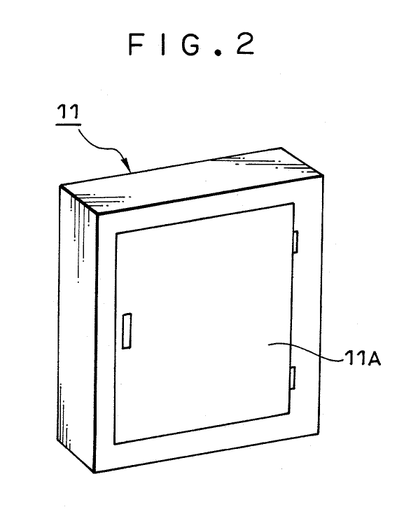

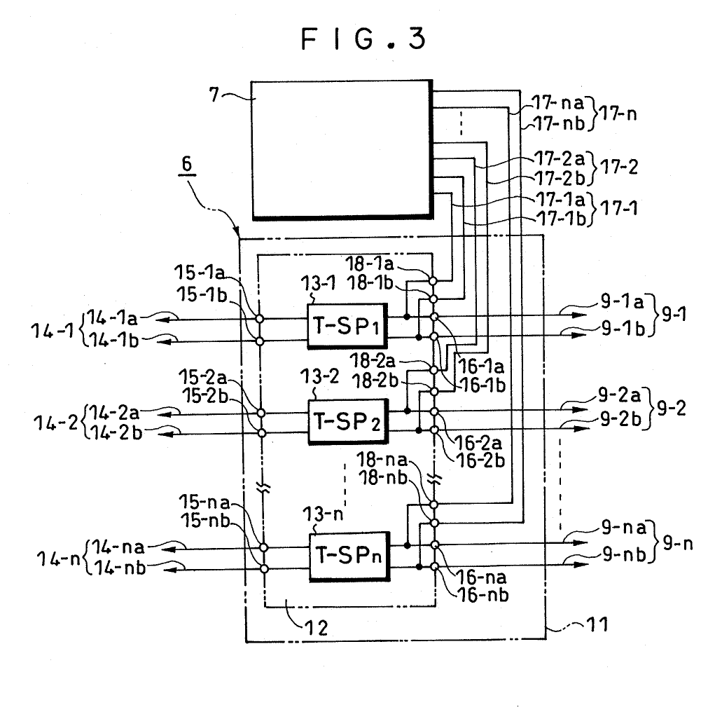

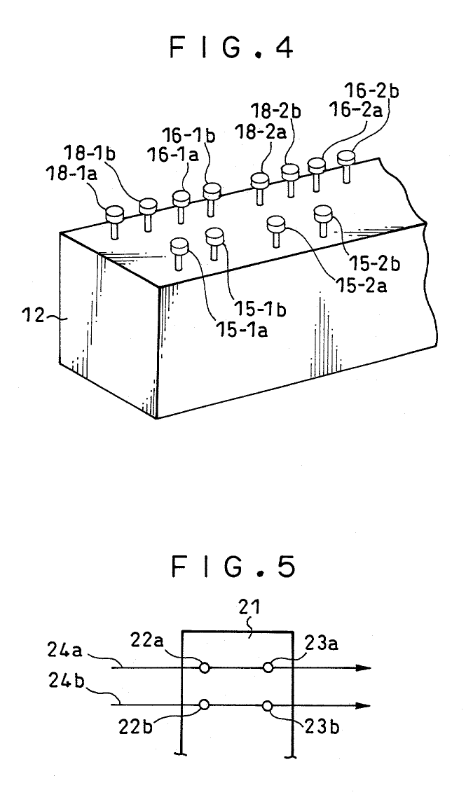

Next, a terminal board 6 in the embodiment of the present invention will be specifically explained with reference to FIG. 2 and FIG. 3.

First, a terminal board 6 is structured to have, as its main components, an accommodating case 11 and a connecting terminal block 12 (refer to FIG. 2 and FIG. 3), and it is installed in an appropriate place of the centralized protector room 51.

The accommodating case 11 is formed, for example, in a rectangular parallelepiped shape as shown in FIG. 2, which shows one example thereof, and on one surface thereof, it is provided with a door 11A which opens and closes freely to accommodate the connecting terminal block 12 therein.

A connecting terminal block 12 is structured to have, as its main components, terminal-board-side splitters (denoted by ‘T-SP₁’ to ‘T-SPₙ’ in FIG. 3) 13-1 to 13-n which are disposed according to the number of the telephone sets 2-1 to 2-n inside the collective building 100; telephone wire connecting terminals 15-1a, 15-1b to 15-na, 15-nb to which the telephone wires 14-1 to 14-n from the external part are connected as described next; home-side connecting terminals 16-1a, 16-1b to 16-na, 16-nb to which the home-side wires 9-1 to 9-n are connected; and switch connecting terminals 18-1a, 18-1b to 18-na, 18-nb to which the switch connecting wires 17-1 to 17-n connected to the line concentration switch 7 are connected, and they are integrally structured in a connecting terminal block 12 (refer to FIG. 3).

Incidentally, each of the telephone wires 14-1 to 14-n and the home-side wires 9-1 to 9-n is abstractly shown by one solid line in FIG. 1 from the viewpoint of making the whole configuration easily understandable, but in the configuration example shown in FIG. 3, a connection state in a case when one subscriber telephone line is a twisted pair line is shown.

The terminal-board-side splitters 13-1 to 13-n in the embodiment of the present invention separate telephone signals from digital signals similarly to the aforesaid user-side splitters 3-1 to 3-n, and furthermore, it is provided with a low-pass filter function of passing only the telephone signals.

In this configuration example, the number of the subscriber telephone lines is n corresponding to the number n of the telephone sets inside the collective building 100, and according to this number, n pairs of the telephone wire connecting terminals 15-1 to 15-n are provided in the connecting terminal block 12 (refer to FIG. 3). Two of each of the telephone wire connecting terminals 15-1 to 15-n are provided for one subscriber telephone line since the telephone wire is a twisted pair line, and the telephone wires 14-1 to 14-n are connected thereto respectively.

To these telephone wire connecting terminals 15-1 to 15-n, corresponding connecting parts of the terminal-board-side splitters 13-1 to 13-n which are provided for the respective subscriber telephone lines are also connected.

Meanwhile, the home-side connecting terminals 16-1 to 16-n and the switch connecting terminals 18-1 to 18-n are also provided according to the number of the subscriber telephone lines respectively, two of each being provided for one subscriber telephone line.

The connection state of the above is explained, taking one set of the home-side connecting terminals 16-1a, 16-1b and the switch connecting terminals 18-1a, 18-1b, for example. First, the home-side connecting terminals 16-1a, 16-1b and the switch connecting terminals 18-1a, 18-1b are both connected to the other connecting parts of a terminal-board-side splitter 13-1. Incidentally, the connection on these parts only need to ensure electrical connection of the home-side connecting terminals 16-1a, 16-1b and the switch connecting terminals 18-1a, 18-1b to a terminal-board-side splitter 13-1, and need not always be in the wiring and connection state as described above or shown in FIG. 3. Therefore, it is of course permissible that, for example, the home-side connecting terminal 16-1a is connected to the switch connecting terminal 18-1a and the home-side connecting terminal 16-1b is connected to the switch connecting terminal 18-1b respectively, and the terminal-board-side splitter 13-1 is connected to either the home-side connecting terminals 16-1a, 16-1b or the switch connecting terminals 18-1a, 18-1b.

In other words, it can be said that the home-side wires 9-1 to 9-n are branched off to the line concentration switch 7 in the connecting terminal block 12.

Incidentally, the connection states of the other home-side connecting terminals 16-2 to 16-n and switch connecting terminals 18-2 to 18-n are basically the same as those described above, and therefore the detailed explanation of each of them is omitted.

To the home-side connecting terminals 16-1 to 16-n, the corresponding home-side wires 9-1 to 9-n are further connected respectively (refer to FIG. 3).

Meanwhile, the switch connecting terminals 18-1 to 18-n are connected to corresponding connecting parts of the line concentration switch 7 via the switch connecting wires 17-1 to 17-n respectively.

Next, the operation in the above configuration will be explained.

Explanation is first given on a case of using a telephone. First, telephone signals from the telephone sets 2-1 to 2-n are sent out to a terminal board 6 via the corresponding user-side splitters 3-1 to 3-n respectively. Incidentally, the telephone signals outputted from the telephone sets 2-1 to 2-n here, which are also applied to the hybrid transformers 4-1 to 4-n, do not influence the personal computers 1-1 to 1-n owing to the acts of the hybrid transformers 4-1 to 4-n.

Then, the telephone signals reaching a terminal board 6 are sent out to the corresponding telephone wires 14-1 to 14-n via the corresponding terminal-board-side splitters 13-1 to 13-n, respectively and are transmitted to intended telephone destinations via the public telephone network 61.

Meanwhile, telephone signals from the external part reach the terminal board 6 via the telephone wires 14-1 to 14-n and are applied to the user-side splitters 3-1 to 3-n via the corresponding terminal-board-side splitters 13-1 to 13-n. Then, these telephone signals reach the corresponding telephone sets 2-1 to 2-n via these user-side splitters 3-1 to 3-n to enable communication. Incidentally, these telephone signals from the external part, which are also applied to the VDSL modems 5-1 to 5-n via the hybrid transformers 4-1 to 4-n, are not applied to the personal computers 1-1 to 1-n since they are not digital signals in a predetermined signal form so that they do not give any interference with the operation of the personal computers 1-1 to 1-n.

Next, explanation is given on a case when the VDSL service is used through the use of the personal computers 1-1 to 1-n. First, digital signals outputted to the Internet 62 from the personal computers 1-1 to 1-n are modulated to signals suitable for the VDSL service by the VDSL modems 5-1 to 5-n and sent to the terminal board 6 via the hybrid transformers 4-1 to 4-n.

The digital signals reaching the terminal board 6 are applied to the corresponding terminal-board-side splitters 13-1 to 13-n and switch connecting terminals 18-1 to 18-n respectively, but the digital signals applied to the terminal-board-side splitters 13-1 to 13-n are not outputted toward the telephone wires 14-1 to 14-n owing to a signal separating function of the terminal-board-side splitters 13-1 to 13-n as previously described.

Meanwhile, the digital signals applied to the switch connecting terminals 18-1 to 18-n are applied to the line concentration switch 7 and applied to the router 8 via this line concentration switch 7. Then, the digital signals applied to the router 8 are sent out to the optical fiber cable 10 after undergoing predetermined processing to establish connection with the Internet 62 via a not-shown provider providing the VDSL service so that high-speed data communication is made possible.

Meanwhile, digital signals sent from the Internet 62 side are applied to the router 8 via the optical fiber cable 10 and outputted to the corresponding personal computers 1-1 to 1-n from the line concentration switch 7. The digital signals outputted from the line concentration switch 7 are applied to the corresponding user-side splitters 3-1 to 3-n and hybrid transformers 4-1 to 4-n. However, in the user-side splitters 3-1 to 3-n, these digital signals are not applied toward the telephone sets 2-1 to 2-n owing to the aforesaid signal separating function so that they do not interfere with the operation of the telephone sets 2-1 to 2-n.

Meanwhile, the digital signals applied to the hybrid transformers 4-1 to 4-n are outputted to the VDSL modems 5-1 to 5-n. Then, the digital signals undergo demodulation processing in these VDSL modems 5-1 to 5-n and inputted to the personal computers 1-1 to 1-n to enable high-speed data communication by a VDSL service.

Incidentally, in the above-described configuration example, it is explained that the accommodating case 11 is in a rectangular parallelepiped shape, but the accommodating case 11 is not of course limited to this shape.

Furthermore, the connecting terminal block 12 may have the structure in which, for example, as shown in FIG. 4 showing one example thereof, it is formed in a column shape using an insulating member, the telephone connecting terminals 15-1 to 15-n, the home-side connecting terminals 16-1 to 16-n, and the switch connecting terminals 18-1 to 18-n are provided to stand on one surface thereof at appropriate spaced intervals, and the terminal-board-side splitters 13-1 to 13-n are provided inside the connecting terminal block 12, and therefore, it need not always be formed in a board shape.

Furthermore, in the above-described configuration example, it is explained that the line concentration switch 7 can accommodate n subscriber lines, but when it has a structure in which an “ETHERNET (Registered Trademark)” port is provided and cascade connection is made possible through the use of this “ETHERNET (Registered Trademark)” port, it can cope with the increase in the number of the subscriber telephone lines and furthermore, the number of the VDSL port can be increased. Therefore, this structure is more preferable.

Moreover, in the above-described configuration, it is explained that the user-side splitters 3-1 to 3-n, the hybrid transformers 4-1 to 4-n, and the VDSL modems 5-1 to 5-n are disposed as separate structures, but it is also preferable, for example, that cases (not shown) of the VDSL modems 5-1 to 5-n are structured to accommodate the user-side splitters 3-1 to 3-n and the hybrid transformers 4-1 to 4-n.

As described hitherto, according to the present invention, the terminals to which the telephone wires from the external part and the wiring inside the building are connected are structured to be integrally disposed with the splitters so that the effects are brought about that the space for disposing the splitters separately need not be secured unlike the conventional art, and furthermore, the VDSL system can be configured with less wiring work, compared with the conventional art.

What is claimed is

1. A VDSL system configured to enable connection of a telephone set to a public telephone network and connection of a computer to the Internet by a VDSL service via a common wire laid inside a building where the telephone set and the computer are installed, comprising:
a terminal board which is disposed between a telephone wire from the public telephone network and the common wire, to which the telephone wire and the common wire are connected, and which is integrally structured with a terminal-board-side splitter disposed between the telephone wire and the common wire.

2. A VDSL system according to claim 1,
wherein the telephone set is connected to the common wire via a user-side splitter and the computer is connected to the common wire via a VDSL modem and a hybrid transformer, respectively.

3. A VDSL system according to claim 2,
wherein connection to a line concentration switch is realized via a wire which branches off from a connection point of the common wire with the terminal-board-side splitter, the line concentration switch is connected to a router, and the router is connected to an optical fiber cable through which the VDSL service is provided.

4. A VDSL system according to claim 3,
wherein both of the telephone set and the computer are provided in plurality, the common wire is disposed for each set of the telephone set and the computer, and the telephone wires corresponding to the number of the telephone sets are connected to said terminal board.

5. A VDSL system according to claim 4,
wherein the terminal-board-side splitter includes a low-pass filter therein.

6. A VDSL system according to claim 5,
wherein the terminal-board-side splitters are disposed according to the number of subscriber telephone lines.

7. A VDSL system according to claim 6,
wherein said terminal board includes:
a connecting terminal block which has telephone wire connecting terminals to which the telephone wires laid according to the number of the subscriber telephone lines are connected, home-side connecting terminals to which the common wires are connected, switch connecting terminals to which wires to the line concentration switch are connected, and in which the terminal-board-side splitters connected between the telephone wire connecting terminals and the home-side connecting terminals are disposed; and
an accommodating case for accommodating the connecting terminal block.

8. A terminal board for a VDSL system,
wherein said terminal board is installed in a centralized protector room provided inside a collective building where a plurality of telephone sets and computers are provided and where the computers are enabled to execute high-speed data communication by a VDSL service, and said terminal board comprising:
terminal-board-side splitters which are disposed according to the number of the telephone sets and via which telephone wires from an external part laid according to the number of the plural telephone sets and a plurality of common wires are connected to each other, the plural telephone sets and computers being commonly connected to the common wires,
wherein wires are structured to be able to branch off on a side of said terminal-side splitters to which the plural common wires are connected.

9. A terminal board for a VDSL system according to claim 8,
wherein the wires branched off on the sides of said terminal-side splitters to which the plural common wires are connected to a line connection switch, and the line concentration switch is connected to a router which is connected to an optical fiber cable through which the VDSL service is provided, so that the computers are enabled to execute the high-speed data communication by the VDSL service.

10. A terminal board for a VDSL system, comprising:
a connecting terminal block having telephone wire connecting terminals to which telephone wires from a public telephone network are connected, home-side connecting terminals to which common wires are connected, and switch connecting terminals to which wires to a line concentration switch is connected, and in which terminal-side splitters connected between the telephone wire connecting terminals and the homeside connecting terminals are disposed; and
an accommodating case for accommodating said connecting terminal block,
wherein the switch connecting terminals and the home-side connecting terminals are in a state of being electrically connected to each other, and
wherein said terminal board is installed in a centralized protector room inside a collective building where a plurality of telephone sets and computers are disposed.

11. A connecting terminal block for a VDSL system, comprising:
telephone wire connecting terminals to which telephone wires from a public telephone network are connected;
home-side connecting terminals to which common wires are connected; and
switch connecting terminals to which wires to a line concentration switch are connected, and
terminal-board-side splitters which are connected between said telephone wire connecting terminals and said home-side connecting terminals and which are disposed in said connecting terminal block,
wherein said switch connecting terminals and said home-side connecting terminals are in a state of being electrically connected to each other.
